(19) United States
(12) Patent Application Publication
(10) Pub. No.: US 2010/0047746 A1
(43) Pub. Date: Feb. 25, 2010

(54) Educational Game For Teaching Sustainability Concepts

(76) Inventors: Nina E. Goodrich, Flamborough (CA); Marie Berard, Chatour (FR); Lori Bogdanis, Montreal (CA); Laurence Kerleroux, Champigny Sur Marne (FR); Xavier Martelli, Saint Maur (FR); Jacqueline A. Murray, Pointe-Claire (CA)

Correspondence Address: QUARLES & BRADY LLP, 411 E. WISCONSIN AVENUE, SUITE 2040, MILWAUKEE, WI, 53202-4497, US

(21) Appl. No.: 12/196,401

(22) Filed: Aug. 22, 2008

(51) Int. Cl. G09B 19/22

(52) U.S. Cl. 434/129

(57) ABSTRACT

An educational game for teaching sustainability concepts includes a first group of “Social” cards provided with a social issue question and a corresponding answer, a second group of “Environmental” cards provided with an environmental issue question and a corresponding answer, and a third group of “Economic” cards provided with an economic issue question and a corresponding answer. The game also includes a game board having a circular path including a plurality of marked spaces indicating which type of card is to be selected. The game also includes a scorekeeping device for keeping track of the number of questions answered correctly by a player. The scorekeeping device includes (i) a scoring surface having a representation of a carbon footprint and (ii) carbon offset counters wherein a player covers a part of the scoring surface with a counter each time a question is answered correctly. When the scoring surface is completely covered by a predetermined number of the carbon offset counters, a player has won a round of the game.

### CROSS-REFERENCES TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The invention relates to an educational game for teaching sustainability concepts.

2. Description of the Related Art

The term “sustainable development” has numerous definitions. In a 1987 report of the World Commission on Environment and Development, sustainable development was defined as development that meets the needs of the present without compromising the ability of future generations to meet their own needs. Concepts of sustainability often build on this broad definition. For example, sustainability research may focus on how to make human economic systems last longer and have less impact on ecological systems.

In the article entitled “Sustainability: Human, Social, Economic and Environmental” (available at http://www.wiley.co.uk/wileychi/egec/pdf/GA811-W.PDF), it is reported that the four main types of sustainability are human, social, economic, and environmental. Human sustainability is defined as maintaining an individual's human capital by investments, such as education, health, and nutrition, throughout an individual's lifetime. Human capital is a private good of individuals, rather than between individuals or societies.

Social sustainability is defined as maintaining social capital, which is investments and services that create the basic framework for society. For example, the cohesion of communities for mutual benefit, connectedness between groups of people, and commonly shared rules and laws are cited as promoting social sustainability.

Environmental sustainability is defined as seeking to improve human welfare by protecting natural capital such as water, land, air, minerals and ecosystem services. Environmental sustainability is described as requiring that natural capital be maintained, by keeping the harvest rates of renewables within regeneration rates, by keeping the depletion rates of non-renewables equal to the rate at which renewable substitutes are created, and by holding waste emissions within the assimilative capacity of the environment without impairing the environment.

Economic sustainability is defined as maintenance of capital. For instance, the amount one can consume during a period and still be as well off at the end of the period is cited as defining economic sustainability.

Corporations are now applying social, environmental and economic sustainability concepts in corporate social responsibility policies. The term “triple bottom line” has been used to describe corporations that have moved beyond reporting only their financial bottom line to reporting on three of the types of sustainability mentioned above: social, environmental, and economic. It has been suggested that the triple bottom line principle is a useful approach for examining the operations of a major corporation.

The social aspect of triple bottom line reporting can refer to reporting on the beneficial business practices of a corporation toward the communities in which the corporation conducts business. For example, a triple bottom line corporation business may contribute to its community with such things as health care and education.

The environmental aspect of triple bottom line reporting can refer to reporting on sustainable environmental practices. For example, a triple bottom line corporation can reduce its ecological footprint by managing its consumption of natural resources and reducing manufacturing waste as well as disposing of waste in a safe manner. The term “cradle to grave” has been used by triple bottom line corporations that conduct a life cycle assessment of products to determine what the true environmental cost is from the extraction of natural resources to manufacture to distribution to eventual disposal by the end user.

The economic aspect of triple bottom line reporting can refer to reporting on profits. However, within a sustainability framework, the profits may be seen as the economic benefit enjoyed by the host society.

Every corporation using triple bottom line reporting may have different views on what social, environmental and economic sustainability mean. Furthermore, individuals wishing to incorporate sustainability concepts into daily living may be uncertain as to the personal and/or public activities that come within the broad definition of social, environmental and economic sustainability.

Thus, there is a need for an educational tool for teaching sustainability concepts to individuals, or groups of individuals working in governmental, educational or corporate institutions.

### SUMMARY OF THE INVENTION

The foregoing needs are met by an educational game according to the invention. The game was created to help a person develop a framework for personal understanding of sustainability. The game teaches through questions and answers in each of the social, environmental, and economic sustainability categories. Question and answer cards are divided into social questions, economic questions and environmental questions to encompass the triple bottom line approach to sustainability. The game includes animal playing tokens that represent threatened species on earth. The game has a game board that includes a continuous circular token movement path encircling a partial global map projection to represent a cradle to cradle approach for sustainable thinking.

The game includes carbon offset counters. A carbon footprint scoring surface is provided for one or more geographic regions such as North America or Europe. The carbon footprint scoring surface is sectioned into direct and indirect elements. Indirect contributions to our carbon footprints come from infrastructure in our society. It is our roads, community buildings, offices, hospitals and schools etc. The direct elements are indicated by icons and include averages for water, transportation, heating, food and electricity. The direct carbon footprint area is the area where an individual has control. The players cover the carbon footprint scoring surface with carbon offset counters during play.

In the game, there are also chance question cards to provide an opportunity to customize the game for a particular group or audience such as governmental, educational or corporate institutions. The chance cards can also include some ecological do's and don'ts cards, reward cards with instructions to receive carbon offset counters, and forfeit cards with instructions to take away a carbon offset counter depending on the situation.

One educational outcome of the game is to create an understanding of our personal carbon footprints and offset our carbon footprint by answering the questions correctly. The game is a teaching tool and is about learning the correct answers and changing our behaviors. The game can be played in companies, schools, tradeshows or anywhere else people are willing to learn about sustainability.

Thus, in one aspect, the invention provides an educational game for teaching sustainability concepts. The game includes a first group of cards wherein each card in the first group is provided with a social issue question and a corresponding answer. These cards may be labeled “Social” on one surface. The game includes a second group of cards wherein each card in the second group is provided with an environmental issue question and a corresponding answer. These cards may be labeled “Environmental” on one surface. The game includes a third group of cards wherein each card in the third group is provided with an economic issue question and a corresponding answer. These cards may be labeled “Economic” on one surface.

The game also includes a game board having a circular path including a plurality of marked spaces. At least one of the marked spaces includes a first “Social” symbol indicating that a card from the first “Social” group is to be selected. At least one of the marked spaces includes a second “Environmental” symbol indicating that a card from the second “Environmental” group is to be selected. At least one of the marked spaces includes a third “Economic” symbol indicating that a card from the third “Economic” group is to be selected. Typically, there is a plurality of each of the first “Social” symbol, the second “Environmental” symbol, and the third “Economic” symbol in the path. In one form, the game board depicts at least a part of a global map projection, and the path encircles the global map projection.

The game includes means for determining a player's game position on the plurality of marked spaces. The means for determining a player's game position on the plurality of marked spaces can be tokens for movement on the plurality of marked spaces during play, and a number generator for determining extent of movement on the plurality of marked spaces during play. The tokens can include a representation of a threatened species. The means for determining a player's game position on the plurality of marked spaces can be a number spinner that points at one of the marked spaces.

The game also includes a scorekeeping device for keeping track of a number of social issue questions, environmental issue questions, and economic issue questions answered correctly by a player. The scorekeeping device includes a scoring surface and a plurality of “carbon offset” counters wherein the counters and the scoring surface are dimensioned such that the plurality of counters covers the scoring surface when a predetermined number of social issue questions, environmental issue questions, and economic issue questions has been answered correctly. When a player answers the predetermined number of social issue questions, environmental issue questions, and economic issue questions correctly, the scoring surface will be completely covered by the plurality of counters indicating that the player has won one round of the game. In one form, the scorekeeping device includes a side wall extending upward from the scoring surface, and the plurality of counters are retained within the side wall. When the scoring surface is completely covered by the plurality of counters, the counters fill the volume defined by the side wall and the scoring surface. The scoring surface can include a representation of a carbon footprint. The carbon footprint can include indications of activities contributing to gaseous emissions, and the carbon footprint can include gaseous emission numerical values associated with each activity.

In one version of the game, the game further includes a fourth group of “Chance” cards wherein at least one card in the fourth group is provided with text selected from one of (i) a social issue question and corresponding answer, (ii) an environmental issue question and corresponding answer, (iii) an economic issue question and corresponding answer, (iv) an instruction to add a counter to the scoring surface, and (v) an instruction to remove a counter from the scoring surface. At least one of the marked spaces of the circular game board path can include a fourth “Chance” symbol indicating that a card from the fourth “Chance” group is to be selected. Also, the game board can include a marked region for placing each of the first group of cards, the second group of cards, the third group of cards, and the fourth group of cards.

In another aspect, the invention provides an educational game for teaching sustainability concepts. The game includes a first group of cards wherein each card in the first group is provided with a social issue question and a corresponding answer. These cards may be labeled “Social” on one surface. The game includes a second group of cards wherein each card in the second group is provided with an environmental issue question and a corresponding answer. These cards may be labeled “Environmental” on one surface. The game includes a third group of cards wherein each card in the third group is provided with an economic issue question and a corresponding answer. These cards may be labeled “Economic” on one surface. The game includes a fourth group of cards wherein at least one card in the fourth group is provided with text selected from one of (i) a social issue question and corresponding answer, (ii) an environmental issue question and corresponding answer, (iii) an economic issue question and corresponding answer, (iv) an instruction to add a value to the number of social issue questions, environmental issue questions, and economic issue questions answered correctly, and (v) an instruction to subtract a value from the number of social issue questions, environmental issue questions, and economic issue questions answered correctly. These cards may be labeled “Chance” on one surface.

The game also includes a game board having a circular path including a plurality of marked spaces. At least one of the marked spaces includes a first “Social” symbol indicating that a card from the first “Social” group is to be selected. At least one of the marked spaces includes a second “Environmental” symbol indicating that a card from the second “Environmental” group is to be selected. At least one of the marked spaces includes a third “Economic” symbol indicating that a card from the third “Economic” group is to be selected. At least one of the marked spaces includes a first “Chance” symbol indicating that a card from the first “Chance” group is to be selected. Typically, there is a plurality of each of the first “Social” symbol, the second “Environmental” symbol, the third “Economic” symbol, and the fourth “Chance” symbol in the path. The game board can include a marked region for placing each of the first group of cards, the second group of cards, the third group of cards, and the fourth group of cards. In one form, the game board depicts at least a part of a global map projection, and the path encircles the global map projection.

The game also includes a scorekeeping device for keeping track of a number of social issue questions, environmental issue questions, and economic issue questions answered correctly by a player. The scorekeeping device includes a scoring surface and a plurality of “carbon offset” counters wherein the counters and the scoring surface are dimensioned such that the plurality of counters covers the scoring surface when a predetermined number of social issue questions, environmental issue questions, and economic issue questions has been answered correctly. When a player answers the predetermined number of social issue questions, environmental issue questions, and economic issue questions correctly, the scoring surface will be completely covered by the plurality of carbon offset counters indicating that the player has won one round of the game. In one form, the scorekeeping device includes a side wall extending upward from the scoring surface, and the plurality of counters are retained within the side wall. When the scoring surface is completely covered by the plurality of counters, the “carbon offset” counters fill the volume defined by the side wall and the scoring surface. The scoring surface can include a representation of a carbon footprint. The carbon footprint can include indications of activities contributing to gaseous emissions, and the carbon footprint can include gaseous emission numerical values associated with each activity.

In yet another aspect, the invention provides an educational game for teaching sustainability concepts. The game includes a first group of cards wherein each card in the first group is provided with a social issue question and a corresponding answer. These cards may be labeled “Social” on one surface. The game includes a second group of cards wherein each card in the second group is provided with an environmental issue question and a corresponding answer. These cards may be labeled “Environmental” on one surface. The game includes a third group of cards wherein each card in the third group is provided with an economic issue question and a corresponding answer. These cards may be labeled “Economic” on one surface.

The game also includes a game board having a circular path including a plurality of marked spaces. At least one of the marked spaces includes a first “Social” symbol indicating that a card from the first “Social” group is to be selected. At least one of the marked spaces includes a second “Environmental” symbol indicating that a card from the second “Environmental” group is to be selected. At least one of the marked spaces includes a third “Economic” symbol indicating that a card from the third “Economic” group is to be selected. Typically, there a plurality of each of the first “Social” symbol, the second “Environmental” symbol, and the third “Economic” symbol in the path.

The game includes a scorekeeping device for keeping track of a number of social issue questions, environmental issue questions, and economic issue questions answered correctly. The scorekeeping device includes a scoring surface including a representation of a carbon footprint. The carbon footprint can include indications of activities contributing to gaseous emissions, and the carbon footprint can include gaseous emission numerical values associated with each activity. The scorekeeping device includes a plurality of “carbon offset” counters wherein the counters and the carbon footprint are dimensioned such that the plurality of “carbon offset” counters covers the entire carbon footprint when a predetermined number of social issue questions, environmental issue questions, and economic issue questions has been answered correctly. When a player answers the predetermined number of social issue questions, environmental issue questions, and economic issue questions correctly, the scoring surface will be completely covered by the plurality of “carbon offset” counters indicating that the player has won one round of the game.

Therefore, one advantage of the educational game of the invention is the capability to teach sustainable thinking by relating it to personal and business situations.

Another advantage of the educational game of the invention is the capability to create an awareness and a framework to think about sustainability trade offs.

Yet another advantage of the educational game of the invention is the capability to help an organization to better respond to customer requests for information on sustainability.

Still another advantage of the educational game of the invention is the capability to teach cradle to cradle thinking.

Yet another advantage of the educational game of the invention is the capability to teach the three pillars (social, environmental and economic) in corporate social responsibility policies and triple bottom line reporting.

Still another advantage of the educational game of the invention is the capability to teach the relative roles of contribution to carbon dioxide emissions.

Yet another advantage of the educational game of the invention is the capability to teach an individual carbon footprint and how the actions of individuals matter.

Still another advantage of the educational game of the invention is the capability to teach ecological facts to help customer conversations with suppliers.

These and other features, aspects, and advantages of the present invention will become better understood upon consideration of the following detailed description, drawings and appended claims.

### BRIEF DESCRIPTION OF THE DRAWINGS

FIG. 1 is a top plan view of a game board used with a game according to the invention.

FIG. 2 are perspective views of example playing tokens used with a game according to the invention.

FIG. 3 is a perspective view of an example number generator used with a game according to the invention.

FIG. 4 is a partially exploded perspective view of an example scorekeeping device used with a game according to the invention.

FIG. 5 is a top plan view of the scorekeeping device of FIG. 4 with all of the counters removed.

FIG. 6 shows a front view (on the left) and a rear view (on the right) of an example social card used with a game according to the invention.

FIG. 7 shows a front view (on the left) and a rear view (on the right) of an example environmental card used with a game according to the invention.

FIG. 8 shows a front view (on the left) and a rear view (on the right) of an example economic card used with a game according to the invention.

FIG. 9 shows a front view (on the left) and a rear view (on the right) of an example chance card used with a game according to the invention.

FIG. 10 is a top plan view of another version of a game board used with a game according to the invention.

Like reference numerals will be used to refer to like parts from Figure to Figure in the following description of the drawings.

### DETAILED DESCRIPTION OF THE INVENTION

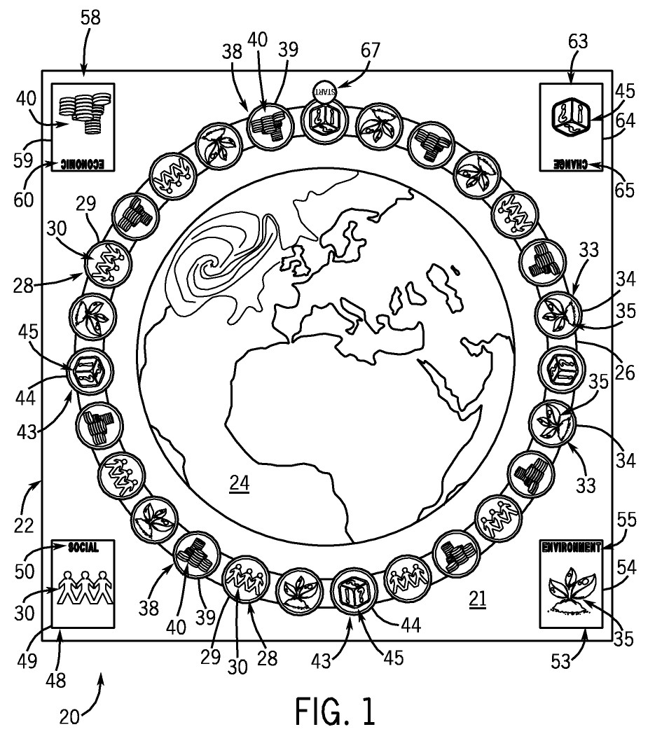

Turning to FIGS. 1-9, there is shown the components of an example embodiment of an educational game according to the invention for teaching sustainability. In FIG. 1, there is shown a top view of an example game board 20 that can be used with the educational game. The game board 20 can be printed on a flat surface 21 (such as a sheet of paper or cardboard) and therefore, the front view, the rear view, the left side view, the right side view, and the bottom view are not shown. The game board 20 includes a rectangular perimeter 22 and a central global projection 24 that shows parts of Africa, Europe, Asia, North America, and South America with generally circular cloud cover west of Europe. Other global projections (with or without cloud cover) would also be suitable for the game board 20.

Still referring to FIG. 1, a circular playing path 26 encircles the central global projection 24. The path 26 includes a first type of marked space 28 having a perimeter 29 encircling a first “Social” symbol 30, which in this version of the game board 20 is a depiction of three persons. In one example version of the game, the first type of marked space 28 is colored yellow. The path 26 includes a second type of marked space 33 having a perimeter 34 encircling a second “Environmental” symbol 35, which in this version of the game board 20 is a depiction of a plant. In one example version of the game, the second type of marked space 33 is colored green. The path 26 includes a third type of marked space 38 having a perimeter 39 encircling a third “Economic” symbol 40, which in this version of the game board 20 is a depiction of coins. In one example version of the game, the third type of marked space 38 is colored blue. The path 26 includes a fourth type of marked space 43 having a perimeter 44 encircling a fourth “Chance” symbol 45, which in this version of the game board 20 is a depiction of a die with punctuation marks. In one example version of the game, the fourth type of marked space 43 is colored orange. Other appropriate symbols can be selected for use as the symbols 30, 35, 40, 45. The marked spaces 28, 33, 38, 43 may be arranged in a repeating pattern around the path 26, or alternatively may by randomly arranged. One or more than one of each of the marked spaces 28, 33, 38, 43 may be used in the path 26. In the embodiment shown, a plurality of each of the marked spaces 28, 33, 38, 43 is used in the path.

The game board 20 includes a first card placement space 48 having a rectangular perimeter 49 around a larger version of the first “Social” symbol 30 and “Social” lettering 50. The game board 20 includes a second card placement space 53 having a rectangular perimeter 54 around a larger version of the second “Environmental” symbol 35 and “Environmental” lettering 55. The game board 20 includes a third card placement space 58 having a rectangular perimeter 59 around a larger version of the third “Economic” symbol 40 and “Economic” lettering 60. The game board 20 includes a fourth card placement space 63 having a rectangular perimeter 64 around a larger version of the fourth “Chance” symbol 45 and “Chance” lettering 65. The card placement spaces 48, 53, 58, 63 may be arranged in the four corners of the game board 20 as in the version shown, or alternatively may by randomly arranged on the game board 20. A “start” indicator 67 is also placed next to one marked space on the game board 20.

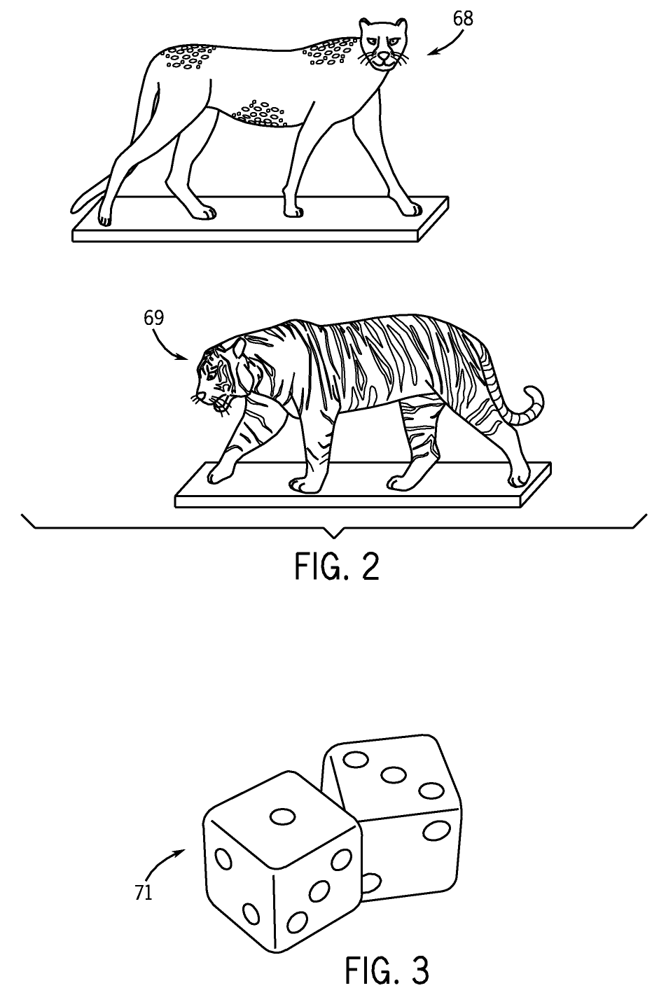

FIG. 2 shows perspective views of a first example playing token 68 and a second example playing token 69 that can be used with the educational game according to the invention. The first example playing token 68 shows the threatened species, cheetah. The second example playing token 69 shows the threatened species, Siberian tiger.

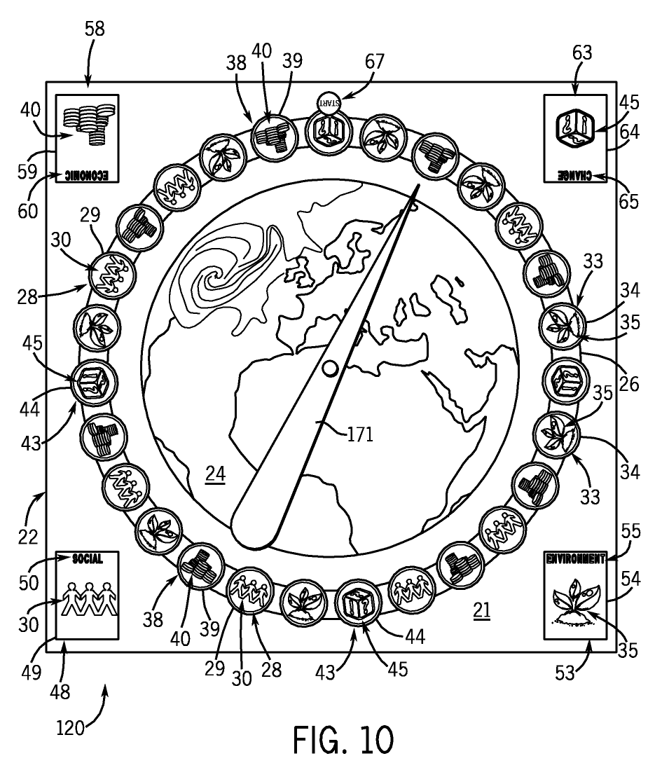

FIG. 3 is a perspective view of a pair of dice 71 that may be a number generator that can be used with the educational game according to the invention. Other number generators may be substituted for the dice 71. For example, FIG. 10 shows a top plan view of another version of a game board 120 used with a game according to the invention. The game board 120 uses a number spinner 171 to control as the.

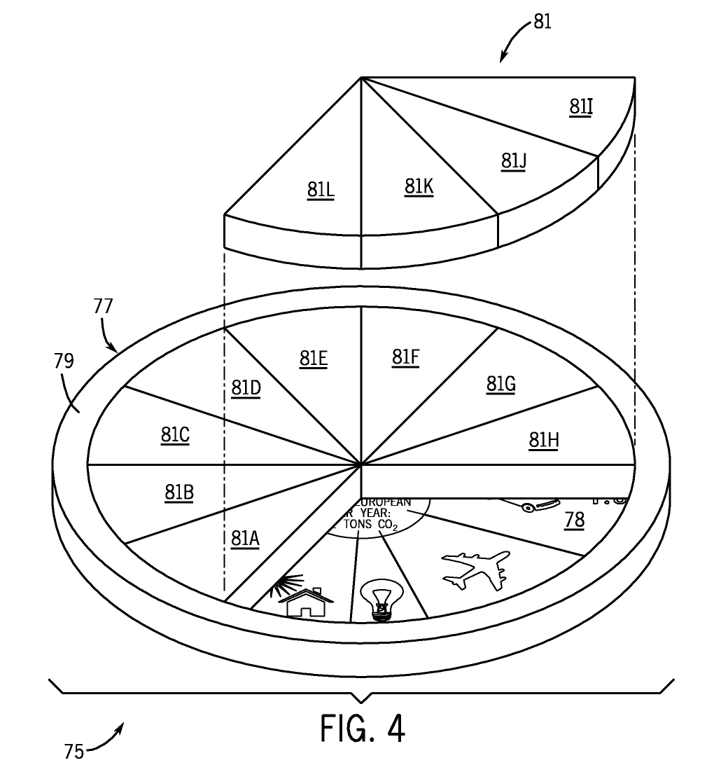

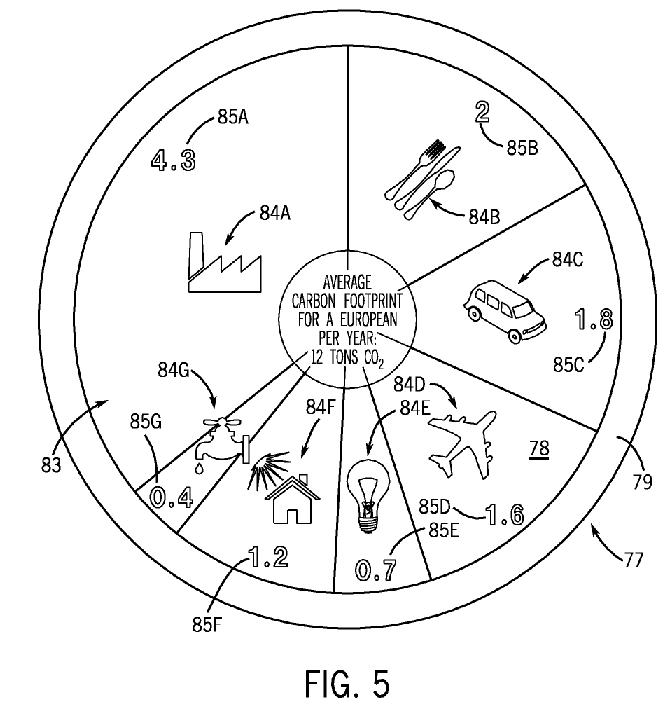

FIGS. 4 and 5 show an example scorekeeping device 75 that can be used with the educational game according to the invention. The scorekeeping device 75 includes a holder 77 having a bottom scoring surface 78 and a circular side wall 79 that extends upward from the scoring surface 78. The scorekeeping device 75 also includes twelve equally sized wedge shaped counters 81 (individually labeled 81A-81L in FIGS. 4 and 5) signifying carbon offsets. The counters 81A-81L are dimensioned such that when all twelve counters 81A-81L are placed within the side wall 79 of the holder 77, the bottom scoring surface 78 is completely covered and the counters 81A-81L are retained with the interior space of the side wall 79. In one example version of the game, some of the counters 81A-81L are colored yellow to signify a social carbon offset; some of the counters 81A-81L are colored green to signify an environmental carbon offset; and some of the counters 81A-81L are colored blue to signify an economic carbon offset. Looking at FIG. 5, the scoring surface 78 includes a representation of a carbon footprint 83. The carbon footprint 83 includes indications 84A-84G of activities contributing to gaseous emissions. The carbon footprint 83 also includes gaseous emission numerical values 85A-85G associated with each activity.

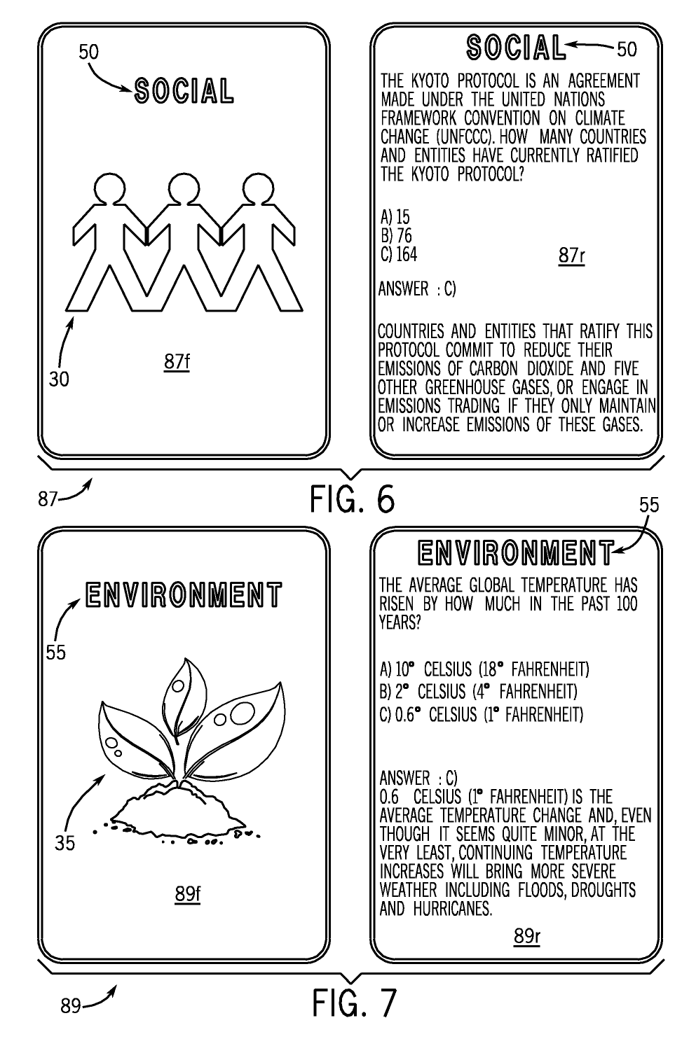

FIG. 6 shows a front surface 87f and a rear surface 87r of an example social card 87 that can be used with the educational game according to the invention. The front surface 87f includes larger versions of the first “Social” symbol 30 and “Social” lettering 50. The rear surface 87r includes a social issue question and answer. Only one social card 87 is shown for illustrative purposes; however, a stack of numerous social cards 87, each having the same front surface 87f and a different social issue question and answer is provided for use in the game. The stack of numerous social cards 87 may be placed on the first card placement space 48 during play.

FIG. 7 shows a front surface 89f and a rear surface 89r of an example environmental card 89 that can be used with the educational game according to the invention. The front surface 89f includes larger versions of the second “Environmental” symbol 35 and “Environmental” lettering 55. The rear surface 89r includes an environmental issue question and answer. Only one environmental card 89 is shown for illustrative purposes; however, a stack of numerous environmental cards 89, each having the same front surface 89f and a different environmental issue question and answer is provided for use in the game. The stack of numerous environmental cards 89 may be placed on the second card placement space 53 during play.

FIG. 8 shows a front surface 91f and a rear surface 91r of an example economic card 91 that can be used with the educational game according to the invention. The front surface 91f includes larger versions of the second “Economic” symbol 40 and “Economic” lettering 60. The rear surface 91r includes an economic issue question and answer. Only one economic card 91 is shown for illustrative purposes; however, a stack of numerous economic cards 91, each having the same front surface 91f and a different economic issue question and answer is provided for use in the game. The stack of numerous economic cards 91 may be placed on the third card placement space 58 during play.

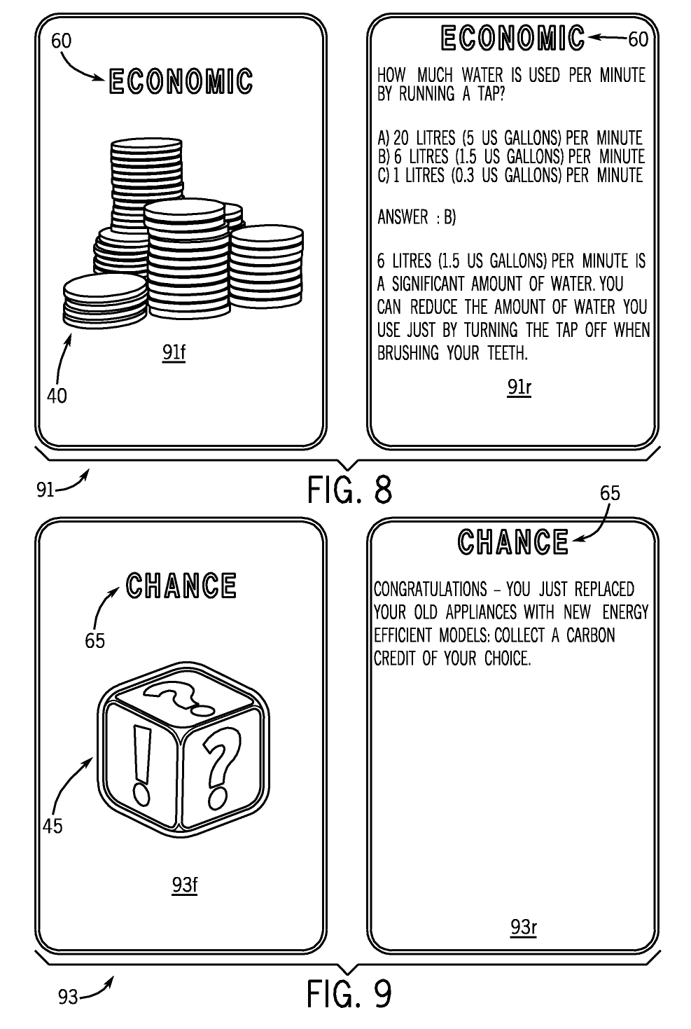

FIG. 9 shows a front surface 93f and a rear surface 93r of an example chance card 93 that can be used with the educational game according to the invention. The front surface 93f includes larger versions of the second “Chance” symbol 45 and “Chance” lettering 65. The rear surface 91r can include text with various questions and answers, or game instructions. One non-limiting example stack of numerous chance cards 93 includes text on the rear surface 91r of one or more of the following: (i) a social issue question and corresponding answer, (ii) an environmental issue question and corresponding answer, (iii) an economic issue question and corresponding answer, (iv) an instruction to add a counter 81 to the scoring surface 78, and (v) an instruction to remove a counter 81 to the scoring surface 78. The chance cards 93 provide an opportunity to customize the game for a particular group or audience such as governmental, educational or corporate institutions by way of selection of certain cards.

Having described the components of an example embodiment of an educational game according to the invention, the rules of play can be explained further. The game can be played by two or more players (e.g., two players, three players, etc.), or two or more teams of players (e.g., 2 teams with up to 5 players on each team). For ease of explanation, the game is described herein as being played with two players. When playing the educational game, the players use the game board 20, the dice 71, a playing token (such as 68,69) for each player, the carbon offset counters 81 (in yellow, blue and green), a holder 77 including the carbon footprint scoring surface 78 for each player, and the four decks of cards: Social 87, Environmental 89, Economic 91, and Chance 93. The game is set up by placing the stacks of Social 87, Environmental 89, Economic 91, and Chance 93 cards on the first card placement space 48, the second card placement space 53, the third card placement space 58, and the fourth card placement space 63 on the game board 20 as described above. Each player places their selected token (such as 68,69) on the “start” indicator 67 of the game board 20. Each player should have a holder 77 including the carbon footprint scoring surface 78 and access to the carbon offset counters 81 (in yellow, blue and green).

The players roll the dice 71 to see which player goes first. The highest number goes first. The starting player re-rolls the dice 71 to determine the number of marked spaces they can move. The token (such as 68,69) can be moved in either direction on the path 26 of the game board 20. The direction can be changed by the player at each turn if desired. When a token 68,69 lands on one of the marked spaces 28, 33, 38, 43, the opposing player notes the type of marked space (e.g., the first type of yellow marked space 28 having the first “Social” symbol 30), and the opposing player picks a question card from the appropriate stack (e.g., stack of numerous yellow social cards 87). The opposing player asks the question and the player in play has a certain time period (e.g., one minute to submit their final answer).

When a social, environmental, or economic question is correctly answered, the player receives the appropriate colored carbon offset counter 81 (e.g., yellow, green, blue). The carbon offset counter 81 is placed in the holder 77 to cover a portion of the carbon footprint scoring surface 78. As detailed above, chance questions might be a social, environmental, or economic question, or they might award or forfeit a carbon offset counter 81 from the player's holder 77. Whether the question is answered correctly or not, the other player rolls the dice 71 next. In order to win, the player must have at least two carbon offset counters 81 in each color (e.g., yellow, green, blue) in the holder 77. The first player to eliminate (i.e., cover) their carbon footprint scoring surface 78 with a total of twelve carbon offset counters 81A-81L wins the game and becomes carton neutral.

In the game, the carbon footprint of the scoring surface 78 stands for a certain amount of gaseous emissions that are relevant to climate change and associated with human production or consumption activities. The complete circular path 26 around the global projection 24 signifies “Cradle to Cradle” thinking. The game uses animals as the playing tokens (such as 68,69) to call attention to the animals where the habitat is threatened. The carbon offset counters 81 can be thought of as pie pieces are placed in a re-used wide-mouth holder 77 that contains the average footprint carbon footprint 83 of a European (12 tons). Other carbon footprints 83 can also be provided such as a version for North America (24 tons).

When playing the version of the educational game that uses the game board 120 of FIG. 10, the playing tokens (such as 68,69) are omitted and the number spinner 171 is first arranged such that the narrow end of the number spinner 171 points at the “start” indicator 67 of the game board 120. One player spins the number spinner 171 and when motion of the spinner stops, the narrow end of the number spinner 171 will point at one of the marked spaces 28, 33, 38, 43. The opposing player notes the type of marked space that is pointed at by the narrow end of the number spinner 171 (e.g., the first type of yellow marked space 28 having the first “Social” symbol 30), and the opposing player picks a question card from the appropriate stack (e.g., stack of numerous yellow social cards 87). The opposing player asks the question and the player in play has a certain time period (e.g., one minute to submit their final answer).

When a social, environmental, or economic question is correctly answered, the player receives the appropriate colored carbon offset counter 81 (e.g., yellow, green, blue). The carbon offset counter 81 is placed in the holder 77 to cover a portion of the carbon footprint scoring surface 78. As detailed above, chance questions might be a social, environmental, or economic question, or they might award or forfeit a carbon offset counter 81 from the player's holder 77. Whether the question is answered correctly or not, the other player then spins the number spinner 171 and play continues as above. In order to win, the player must have at least two carbon offset counters 81 in each color (e.g., yellow, green, blue) in the holder 77. The first player to eliminate (i.e., cover) their carbon footprint scoring surface 78 with a total of twelve carbon offset counters 81A-81L wins the game and becomes carton neutral.

Thus, the invention provides an educational game to help to develop a framework for personal understanding of sustainability. The game teaches through questions and answers in each of the social, environmental, and economic sustainability categories.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. An educational game for teaching sustainability concepts, the game comprising:
a first group of cards wherein each card in the first group is provided with a social issue question and a corresponding answer;
a second group of cards wherein each card in the second group is provided with an environmental issue question and a corresponding answer;
a third group of cards wherein each card in the third group is provided with an economic issue question and a corresponding answer;
a game board having a path including a plurality of marked spaces, at least one of the marked spaces including a first symbol indicating that a card from the first group is to be selected, at least one of the marked spaces including a second symbol indicating that a card from the second group is to be selected, and at least one of the marked spaces including a third symbol indicating that a card from the third group is to be selected;
means for determining a player's game position on the plurality of marked spaces; and
a scorekeeping device for keeping track of a number of social issue questions, environmental issue questions, and economic issue questions answered correctly, the scorekeeping device including a scoring surface and a plurality of counters wherein the counters and the scoring surface are dimensioned such that the plurality of counters covers the scoring surface when a predetermined number of social issue questions, environmental issue questions, and economic issue questions has been answered correctly.

2. The game of claim 1 wherein:
the game board depicts at least a part of a global map projection, and
the path encircles the global map projection.

3. The game of claim 1 wherein:
the scorekeeping device includes a side wall extending upward from the scoring surface, and
the plurality of counters are retained within the side wall.

4. The game of claim 1 wherein:
the scoring surface includes a representation of a carbon footprint.

5. The game of claim 4 wherein:
the carbon footprint includes indications of activities contributing to gaseous emissions.

6. The game of claim 5 wherein:
the carbon footprint includes gaseous emission numerical values associated with each activity.

7. The game of claim 1 wherein:
the scoring surface includes a representation of a carbon footprint having indications of activities that an individual can control in their carbon footprint.

8. The game of claim 1 wherein:
the game includes a plurality of scoring surfaces, each scoring surface including a representation of a carbon footprint for a geographic region.

9. The game of claim 1 further comprising:
a fourth group of cards wherein at least one card in the fourth group is provided with text selected from one of a social issue question and corresponding answer, an environmental issue question and corresponding answer, an economic issue question and corresponding answer, an instruction to add a counter to the scoring surface, and an instruction to remove a counter from the scoring surface.

10. The game of claim 9 wherein:
at least one of the marked spaces includes a fourth symbol indicating that a card from the fourth group is to be selected.

11. The game of claim 9 wherein:
the game board includes a marked region for placing each of the first group of cards, the second group of cards, the third group of cards, and the fourth group of cards.

12. The game of claim 1 wherein:
the means for determining a player's game position on the plurality of marked spaces comprises tokens including a representation of a threatened species.

13. An educational game for teaching sustainability concepts, the game comprising:
a first group of cards wherein each card in the first group is provided with a social issue question and a corresponding answer;
a second group of cards wherein each card in the second group is provided with an environmental issue question and a corresponding answer;
a third group of cards wherein each card in the third group is provided with an economic issue question and a corresponding answer;
a game board having a path including a plurality of marked spaces, at least one of the marked spaces including a first symbol indicating that a card from the first group is to be selected, at least one of the marked spaces including a second symbol indicating that a card from the second group is to be selected, and at least one of the marked spaces including a third symbol indicating that a card from the third group is to be selected;
a scorekeeping device for keeping track of a number of social issue questions, environmental issue questions, and economic issue questions answered correctly; and
a fourth group of cards wherein at least one card in the fourth group is provided with text selected from one of a social issue question and corresponding answer, an environmental issue question and corresponding answer, an economic issue question and corresponding answer, an instruction to add a value to the number of social issue questions, environmental issue questions, and economic issue questions answered correctly, and an instruction to subtract a value from the number of social issue questions, environmental issue questions, and economic issue questions answered correctly.

14. The game of claim 13 wherein:
the game board includes a marked region for placing each of the first group of cards, the second group of cards, the third group of cards, and the fourth group of cards.

15. The game of claim 13 wherein:
at least one of the marked spaces includes a fourth symbol for indicating that a card from the fourth group is to be selected.

16. The game of claim 13 wherein:
the scorekeeping device includes a scoring surface and a plurality of counters wherein the counters and the scoring surface are dimensioned such that the plurality of counters covers the scoring surface when a predetermined number of social issue questions, environmental issue questions, and economic issue questions has been answered correctly.

17. The game of claim 16 wherein:
the scoring surface includes a representation of a carbon footprint.

18. The game of claim 17 wherein:
the carbon footprint includes indications of activities contributing to gaseous emissions.

19. An educational game for teaching sustainability concepts, the game comprising:
a first group of cards wherein each card in the first group is provided with a social issue question and a corresponding answer;
a second group of cards wherein each card in the second group is provided with an environmental issue question and a corresponding answer;
a third group of cards wherein each card in the third group is provided with an economic issue question and a corresponding answer;
a game board having a path including a plurality of marked spaces, at least one of the marked spaces including a first symbol indicating that a card from the first group is to be selected, at least one of the marked spaces including a second symbol indicating that a card from the second group is to be selected, and at least one of the marked spaces including a third symbol indicating that a card from the third group is to be selected; and
a scorekeeping device for keeping track of a number of social issue questions, environmental issue questions, and economic issue questions answered correctly, wherein the scorekeeping device includes a scoring surface including a representation of a carbon footprint.

20. The game of claim 19 wherein:
the carbon footprint includes indications of activities contributing to gaseous emissions.

21. The game of claim 20 wherein:
the carbon footprint includes gaseous emission numerical values associated with each activity.

22. The game of claim 19 wherein:
the scorekeeping device includes a plurality of counters wherein the counters and the carbon footprint are dimensioned such that the plurality of counters covers the carbon footprint when a predetermined number of social issue questions, environmental issue questions, and economic issue questions has been answered correctly.
